(19) United States
(12) Patent Application Publication
(10) Pub. No.: US 2006/0153320 A1
(43) Pub. Date: Jul. 13, 2006

(54) RF parameterized steerable antenna

(75) Inventor: Scott Frank Gruber, Colorado Springs, CO (US)

Correspondence Address: DAVID W. BARMAN, 1101 NE 176 TERRACE, NORTH MIAMI BEACH, FL, 33162, US

(73) Assignee: zeeWaves Systems, Inc.

(21) Appl. No.: 11/328,044

(22) Filed: Jan. 9, 2006

Related U.S. Application Data
(60) Provisional application No. 60/642,213, filed on Jan. 7, 2005.

(51) Int. Cl. H04L 1/02

(52) U.S. Cl. 375/347

(57) ABSTRACT

Provided is a steerable antenna for directing an RF output signal to a source from which an RF input signal was received. In particular, incoming phase measurements are used to calculate a phase offset. The phase offset is associated with the source and stored for subsequent use. The phase offsets are updated with each received message from the source to ensure accurate position tracking. A phase shifted oscillator uses a negated phase offset to create an output carrier signal that has the same frequency as the antenna master oscillator, but a phase shift adequate to allow the output signal or beam to form in the proper direction, i.e. toward the source. Each antenna element operates in both a transmit and receive mode, thereby ensuring that any time delays associated with the transmit and receive functions cancel one another.

### RELATED APPLICATIONS

This application claims the benefit of priority to U.S. provisional application Ser. No. 60/642,213 filed Jan. 7, 2005 and entitled RF Parameterized Steerable Antenna, which is hereby incorporated by reference to the same extent as though fully replicated herein.

### FIELD OF THE INVENTION

This invention relates generally to wireless communication networks, and in particular to steerable antennas. This invention defines an antenna system and method for determining the direction of arrival of a radio frequency (“RF”) input signal, and for determining an appropriate direction for a return RF signal.

### BACKGROUND

With the wide spread use of wireless communication today, especially in the unlicensed bands, methods are needed to maximize client coverage while minimizing noise and interference. SDMA (Space Division Multiple Access) is often used in a point to multi-point wireless system in order to maximize RF usage in a specific area, maximize useable distance to a client or source, and minimize power consumption by a client. SDMA incorporates antenna beam steering towards and from various transmit sources.

Typically, the direction of arrival of an incoming radio signal, and a direction for sending a return signal, are calculated using digital signal processing (“DSP”) techniques. Many companies today are applying “smart” or steerable antenna techniques at the baseband level. These techniques often use the processing power of application specific integrated circuits to execute DSP algorithms and identify strong sources of interference, and to null these interfering sources accordingly. When a direction to the transmitting source of interest is not known, however, DSP specific antenna systems often nullify strong sources of interference, even if those interfering sources are not in the general vicinity of the transmitting source.

Current “smart” or steerable antenna systems lack the ability to focus or “pre-steer” an RF input or output signal prior to the baseband digital signal processing. As such, a significant portion of the system processing resources are used to nullify or negate interfering signals that are irrelevant to the transmitting source. Hence, there is a need for a “smart” or steerable antenna capable of “pre-steering” an RF signal to address one or more of the drawbacks identified above.

### SUMMARY

The antenna system herein disclosed advances the art and overcomes problems articulated above by providing a system for directing an RF output signal to a source from which an RF input signal was received.

In particular, and by way of example only, according to an embodiment, provided is an antenna system including: at least two antenna elements positioned to detect a radio frequency (“RF”) input signal from a source, and to transmit a corresponding phase-shifted RF output signal to the source; a master oscillator; a phase detector structured and arranged to measure a phase offset between the RF input signal and the master oscillator; a first input phase shifted oscillator, positioned to receive the phase offset from the phase detector for demodulation of the RF input signal to an intermediate frequency (“IF”); the RF input signal to generate an intermediate frequency (“IF”) signal; a second input phase shifted oscillator; an input RF/IF divider positioned to receive the phase offset from the phase detector and, in concert with the second input phase shifted oscillator, to demodulate the IF signal into an In-Phase (“I”) component and Quadrature (“Q”) component for base band processing; an output RF/IF divider positioned to receive a negated phase offset value; a first output phase shift oscillator, structured and arranged to modulate, in concert with the output RF/IF divider, the IF signal; and; a second output phase shift oscillator structured and arranged to receive the negated phase offset and modulate an RF component of the RF output signal, wherein the modulated IF signal and RF component combine to generate the RF output signal.

In another embodiment, provided is a method for directionally transmitting an RF output signal to a source, the method including: detecting, with at least two antenna element, an RF input signal from the source; determining, for each antenna element, a phase offset between the RF input signal and a master oscillator; negating the phase offset in a processor; applying the negated phase offset in a phase shifted oscillator to shift a frequency of an output carrier signal from a first frequency to a second frequency for a predetermined number of cycles, thus shifting a phase of the output carrier signal; returning the output carrier signal to the first frequency; modulating the output carrier signal with an intermediate frequency to generate the RF output signal; and transmitting, through the at least two antenna elements, the RF output signal.

In yet another embodiment, provided is a steerable antenna including: a transmit/receive means for receiving an RF input signal from a source, and for transmitting an RF output signal to the source; a determining means for determining a phase offset between the RF input signal and a master oscillator; an applying means for applying the phase offset to the RF input signal to derive an intermediate frequency; a negating means for negating the phase offset; and a generating means for applying the negated phase offset to an output carrier signal, and for modulating the output carrier signal with the intermediate frequency, to generate the RF output signal.

In still another embodiment, provided is a method of directionally transmitting an RF output signal to a source, of the type wherein an RF input signal is received from the source, and a direction for transmission to the source is determined using data derived from the RF input signal, the improvement including: measuring a phase offset between the RF input signal and a master oscillator; negating the phase offset; applying the negated phase offset in a phase shifted oscillator to shift a frequency of an output carrier signal from a first frequency to a second frequency for a predetermined number of cycles, thus shifting a phase of the output carrier signal; returning the output carrier signal to the first frequency; and modulating the output carrier signal with an intermediate frequency to generate the RF output signal.

### BRIEF DESCRIPTION OF THE DRAWINGS

FIG. 1 is a top view of an incoming RF signal received by one or more antenna elements;

FIG. 2 is a top view of an incoming RF signal received by one or more antenna elements;

FIG. 3 is a coordinate representation of an incident plane wave and the relative distances between antenna elements, according to an embodiment;

FIG. 4 is a coordinate representation of an antenna element as related to the normal of the incident wave front;

FIG. 5 is a coordinate representation of an antenna element as related to the normal of the incident wave front;

FIG. 6 is a coordinate representation of the relationship of a return signal, according to an embodiment;

FIG. 7 is a coordinate representation of the relationship of a return signal, according to an embodiment;

FIG. 8 is a block diagram of multiple antenna element feeds into a central processing unit, according to an embodiment;

FIG. 9 is block diagram of an antenna system, according to an embodiment;

FIG. 10 is a block diagram of the receive path of an antenna system, according to an embodiment;

FIG. 11 is a block diagram of the transmit path of an antenna system, according to an embodiment;

FIG. 12 is a block diagram of a phase shifted oscillator or (“FShifter”), according to an embodiment;

FIG. 13 is a block diagram of a method for receiving an RF input signal, and for transmitting an RF output signal, according to an embodiment; and

FIG. 14 is an example of an output carrier signal from an FShifter, according to an embodiment.

### DETAILED DESCRIPTION

Before proceeding with the detailed description, it should be noted that the present teaching is by way of example, not by limitation. The concepts herein are not limited to use or application with one specific type of antenna system. Thus, although the instrumentalities described herein are for the convenience of explanation, shown and described with respect to exemplary embodiments, the principles herein may be equally applied in other types of antenna systems.

Disclosed is a system and method for acquiring a radio frequency (“RF”) signal from a source, and for determining the required direction for a reply transmission. Once the return direction to the source is known, an RF output signal may be generated and transmitted to the source.

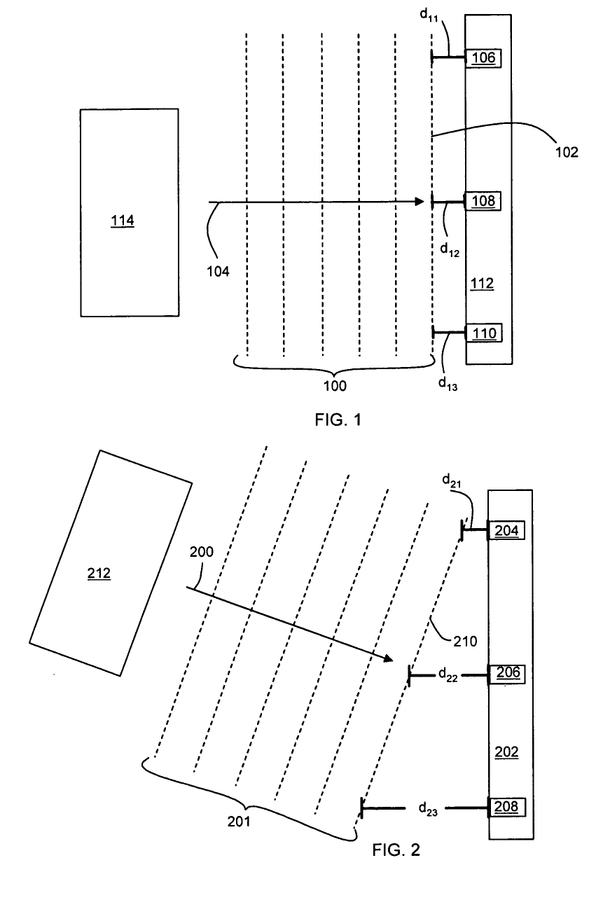

As illustrated in FIG. 1, the physics of an incoming RF signal 100 (or RF input signal) require that the phase of the RF input signal 100 is constant across the wave front 102 of the signal 100, which is perpendicular to the direction of propagation 104. The received phase is thus measured at each element in an array, of which elements 106, 108 and 110 of array 112 are exemplary. Of note, knowing the locations of elements 106-110 is not required, nor is it necessary to know the location of the source 114 of RF input signal 100 As discussed in greater detail below, each element 106-110 is used to receive and transmit corresponding RF signals, thereby ensuring substantially the same receive and transmit delay times as the signal propagates through the antenna circuitry in either a receive or transmit direction.

If the direction of propagation 104 is normal to the array 112 of antenna elements 106-110, as shown in FIG. 1, the distance between any given element and the wave front 102 will be substantially equal, i.e. d₁₁=d₁₂=d₁₃. As represented in FIG. 2, however, the direction of propagation 200 of a signal 201 may not always be normal to the array 202. In this instance, the distance between a given antenna element, such as elements 204, 206 and 208, and the wave front 210 (i.e. d₂₁, d₂₂ and d₂₃ respectively) will not be equal. Stated differently, there will be a temporal difference in detection of the incoming wave front 210 by elements 204-208. As can be appreciated by those skilled in the art, this phase difference may be measured and used to determine an orientation of the wave front 210, and hence a direction to source 212.

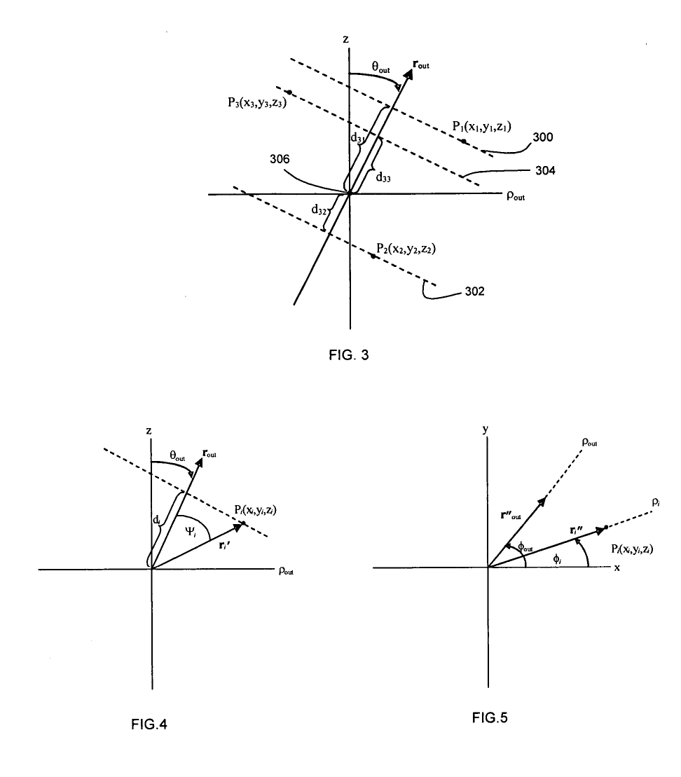

Referring now to FIG. 3, for a desired beam or wave front direction, the phase difference between antenna elements (e.g. elements 204-208 in FIG. 2) can be determined. As discussed above, and graphically illustrated in FIG. 3, the phase difference is based on the distances, e.g. d₃₁, d₃₂ and d₃₃, between perpendicular planes or “wave fronts” 300, 302 and 304, respectively, that intersect each antenna element. For the purposes of this disclosure, each antenna element may be treated as a point source 306 (an isotropic antenna or antenna element with no volume). Data from multiple point sources can be multipled (combined) to represent an entire antenna element array.

Still referring to FIG. 3, the vector, rout represents the direction of propagation for wave fronts 300-304. For an arbitarily chosen reference system, the rₒᵤₜ vector is defined in terms of θₒᵤₜ and ρₒᵤₜ (see also FIGS. 4 and 5). The distances, d₃₁ through d₃₃, represent the distances along rₒᵤₜ between the wave fronts 300-304 that intersect each of the antenna elements 306. To determine the phase distance for an arbitary point Pᵢ, (of which points P₁, P₂, and P₃ are exemplary) the position vector to Pᵢ must be projected onto the rₒᵤₜ vector.

Referring now to FIGS. 4 & 5 of the present disclosure, FIG. 4 represents what may be termed the “z-ρₒᵤₜ”-plane. As shown, rᵢ′ is the projection of rᵢ into this plane, to a point identified as Pᵢ (xᵢ, yᵢ, zᵢ). After determining a value for both rᵢ′ and the angle Ψ, the distance “dᵢ” may be calculated as dᵢ=rᵢ′ cos(Ψᵢ).

Similarly, FIG. 5 represents the “x-y” plane. The double primed vectors, i.e. r″ and rᵢ″ are the projections of these vectors into the “x-y” plane. The dashed lines marked as ρ, or more specifically ρₒᵤₜ and ρᵢ, represent where the “z-ρ” plane would intersect the “x-y” plane.

To aid in the trigonometric manipulations, a new angle, γᵢ=θₒᵤₜ+Ψᵢ, is defined The resulting equations are:

$${γ}_{i} = {tan}^{- 1} [ tan {θ}_{i} cos ( {φ}_{out} - {φ}_{i} ) ]$$

$${d}_{i} = {r}_{i} \frac{cos {θ}_{i}}{cos {γ}_{i}} cos ( {γ}_{i} - {θ}_{out} )$$

The resulting phase shift for the ith antenna element is

$${τ}_{i} = - \frac{2 π {d}_{i}}{λ}$$

where λ is the wavelength of the carrier wave in free space.

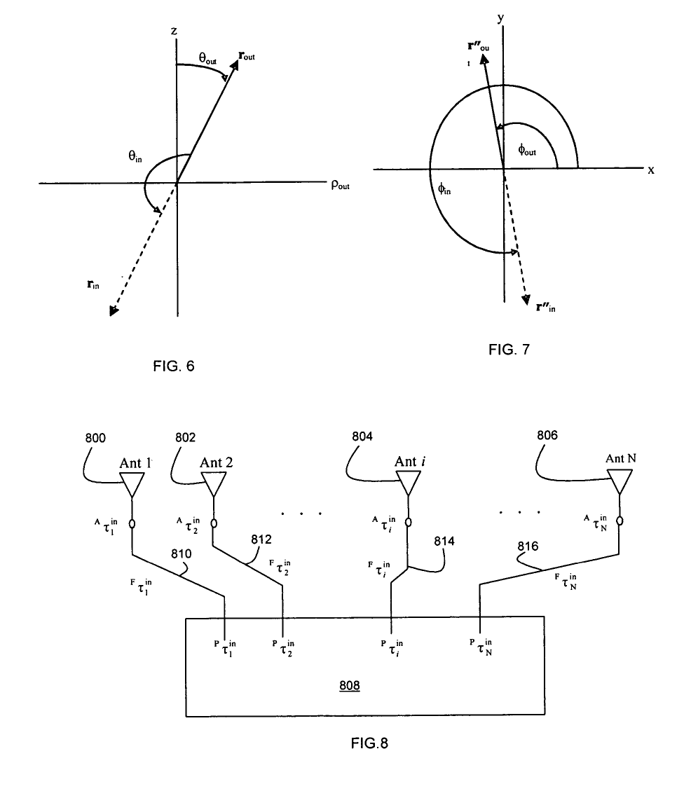

In FIGS. 6 and 7, the dashed vectors represent the incoming direction, rᵢₙ, or as shown rᵢₙ and r″ᵢₙ. Similarly, the return signal “rₒᵤₜ” is represented as a solid vector in the opposite directions of rᵢₙ and r″ᵢₙ. These return signal vectors have been labeled, i.e. rₒᵤₜ and r″ₒᵤₜ respectively. From these figures (FIGS. 6 and 7) it can be appreciated that the following relationships may be determined:
φₒᵤₜ=φᵢₙ+180°
θₒᵤₜ=180° −θᵢₙ

Comparing the equations from the previous discussion, a summary is provided in Table 1.

TABLE 1
Summary of Calculations for Incoming/Outgoing Signals

| Incoming | Outgoing |
|---|---|
| $\begin{matrix}{γ}_{i}^{in} = {tan}^{- 1} [ tan {θ}_{i} cos ( {φ}_{in} - \\ {φ}_{i} ) ] \end{matrix}$ | $\begin{matrix}{γ}_{i}^{out} = {tan}^{- 1} [ tan {θ}_{i} cos ( {φ}_{out} - {φ}_{i} ) ] \\ = {tan}^{- 1} [ tan {θ}_{i} cos ( ( {φ}_{in} + 180 ° ) - {φ}_{i} ) ] \\ = {tan}^{- 1} [ tan {θ}_{i} cos ( {φ}_{in} - {φ}_{i} ) ] \\ = - {γ}_{i}^{in}\end{matrix}$ |
| ${d}_{i}^{in} = {r}_{i} \frac{cos {θ}_{i}}{cos {γ}_{i}^{in}} cos ( {γ}_{i}^{in} - {θ}_{in} )$ | $\begin{matrix}{d}_{i}^{out} = {r}_{i} \frac{cos {θ}_{i}}{cos {γ}_{i}^{in}} cos ( {γ}_{i}^{out} - {θ}_{out} ) \\ = {r}_{i} \frac{cos {θ}_{i}}{cos ( - {γ}_{i}^{in} )} cos ( - {γ}_{i}^{in} - ( 180 ° - {θ}_{in} ) ) \\ = {r}_{i} \frac{cos {θ}_{i}}{cos {γ}_{i}^{in}} cos ( {γ}_{i}^{in} - {θ}_{in} ) \\ = - {d}_{i}^{out}\end{matrix}$ |

It can be seen in Table 1 that the return phase shift, i.e. −γᵢⁱⁿ, is simply the negative of the incident phase shift at a given antenna element, i.e. γᵢⁱⁿ. This relationship is independent of the location of the antenna element, and the location of the source is not required to determine the phase shift.

The phase shift mathematically represented and described above is determined at the antenna element terminal. Referring now to FIG. 8, for a system of the present disclosure, an incoming signal is delayed as it travels from a given antenna element, of which antenna elements 800, 802, 804 and 806 are exemplary, to a processing section or processor 808. As shown in FIG. 8, each antenna element 800-802 is connected to processor 808 via a transmit/receive line, e.g. lines 810, 812, 814 and 816 respectively. For the purposes of this disclosure, a given receive signal, and a corresponding transmit signal, are carried via the same transmit/receive line (e.g. line 810), and are received or transmitted via the same antenna element (e.g. element 800). In this manner, each receive signal and corresponding transmit signal will have the same delay circuitry, and the same delay time traveling through the circuitry.

Still referring to FIG. 8, the received phase at an antenna element, e.g. element 800, is represented as ^{A}τᵢⁱⁿ. Likewise, the phase delay due to the feed from antenna element 800 to processor 808 is represented as ^{F}τᵢⁱⁿ . It can be said, therefore, that the phase as received at processor 808 is given by ^{P}τᵢⁱⁿ=^{A}τᵢⁱⁿ, −^{F}τᵢⁱⁿ. In the operation of the antenna system disclosed herein, the phase of a signal transmitted from processor 808 , i.e. ^{P}τᵢ^{out}, is determined such that the phase of the signal transmitted at element 800 is represented as ^{A}τᵢ^{out}=−^{A}τᵢⁱⁿ. Stated differently, the phase of the transmitted or output RF signal at element 800 is the inverse or negative of the phase of the incoming or input RF signal. Of note, the antenna elements 800-806 are used for both receive and transmit, therefore, for lines 810-816, ^{F}τᵢ^{out}=^{F}τᵢⁱⁿ.

Thus, it can be determined that

$${}^{A} {τ}_{i}^{out} {=}^{P} {τ}_{i}^{out} {-}^{F} {τ}_{i}^{out} ⇒ \begin{matrix}{}^{P} {τ}_{i}^{out} {=}^{A} {τ}_{i}^{out} {+}^{F} {τ}_{i}^{out} \\ = {-}^{A} {τ}_{i}^{i n} {+}^{F} {τ}_{i}^{i n} \\ = {-}^{P} {τ}_{i}^{i n}\end{matrix}$$

and the proper transmit phase shift is achieved by negating the phase measured at processor 808, with the line 810-816 delays for receive and transmit canceling each other.

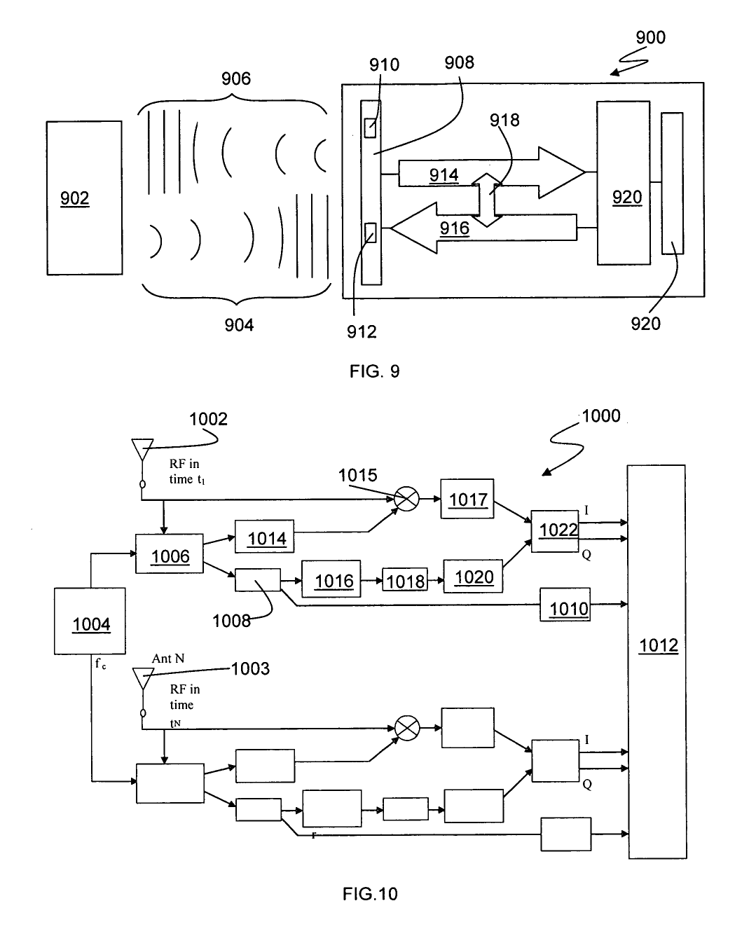

In FIG. 9, a top level block diagram of a steerable antenna/antenna system 900 of the present application is presented. Also depicted is a source 902 for transmitting a signal 904 toward system 900, and for receiving a signal 906 transmitted from system 900. As can be appreciated by those skilled in the art, as either signal 904, 906 is eventually received by receiver elements, the signal 904, 906 will appear to be a substantially linear wave front. Multiple received signals may be used to maintain/update position data related to the source.

System 900 may include an antenna array 908, which may include two or more antenna elements, e.g. elements 910 and 912. Further, system 900 includes both a receive link or pathway, represented by arrow 914, and a transmit link or pathway, represented by arrow 916. As represented by arrow 918, both links may include one or more of the same components, as discussed in greater detail below.

Receive and transmit links 914, 916 may be interconnected electronically to a processor 920 for processing signals (to include digital signal processing), and for deriving data from signals received by system 900. Further, system 900 may include additional support electronics and hardware 922 for facilitating operation, and for integrating with a base station (not shown) or other host.

Considering now the receive link in greater detail, it can be seen in FIG. 10 that the link 1000 includes two or more antenna elements 1002, 1003 interconnected to the remaining link architecture. As shown in FIG. 10, system 900 may include “n” number of antenna elements. The receive link architecture is structured substantially the same for each antenna element. A master oscillator 1004 is interconnected to each antenna element architecture, and tuned to a correct carrier frequency, f_{c}.

A phase detector 1006, of a type well known in the art, is interconnected to master oscillator 1004 to compare the carrier phase to a phase of master oscillator 1004, and to convert the phase difference into a constant voltage level. Interconnected to phase detector 1006 is an analog-to-digital or A/D converter 1008. A/D converter 1008 is also connected to a data storage device 1010, which in turn is connected to a processor 1012. Also, an RF applicable phase shifted oscillator, or RF “FShifter” 1014 is positioned to receive a voltage output from phase detector 1006. As discussed below, the present disclosure includes at least two FShifters, which may be identified as RF or IF (“Intermediate Frequency”) FShifters, depending on whether an RF or IF signal is involved. The specific elements of a FShifter, e.g. RF FShifter 1014, are described in greater detail below. RF FShifter 1014 interconnects to a mixer 1015, which also receives the input carrier signal and, in turn, transmits signals to a filter 1017, wherein demodulation to the IF frequency may occur.

Still referring to FIG. 10, an RF/IF or radio frequency (RF)/Intermediate Frequency (IF) divider 1016 is aligned with A/D converter 1008 to receive an output from the converter 1008, and to relay a signal to a digital-to-analog or D/A converter 1018. D/A converter 1018, in turn, connects to an IF applicable FShifter 1020. In at least one embodiment, the inputs to both RF/IF divider 1016 and IF Fshifter 1020 are analog, therefore A/D and D/A conversions are not required.

The output of IF FShifter 1020 is input into an I/Q splitter 1022. The output of IF FShifter 1020 is in phase with the output of 1017, and is at the IF frequency. In at least one embodiment of the present application, the components of RF Fshifter 1014 and IF FShifter 1020 are substantially the same.

As noted above, connected to processor 1012, and to filter 1017, is I/Q splitter 1022, wherein the RF input signal, demodulated to the IF frequency, is split into its I and Q components for data processing. One or more outputs from I/Q splitter 1022 feed into processor 1012 for digital signal processing as necessary and/or desired. As previously noted, each antenna element in an “n” antenna element array has a receive link or pathway substantially the same as that described above. In the processing of multiple RF input signals, a combining or addition of the discrete signals received by each element is performed to generate an entire received signal.

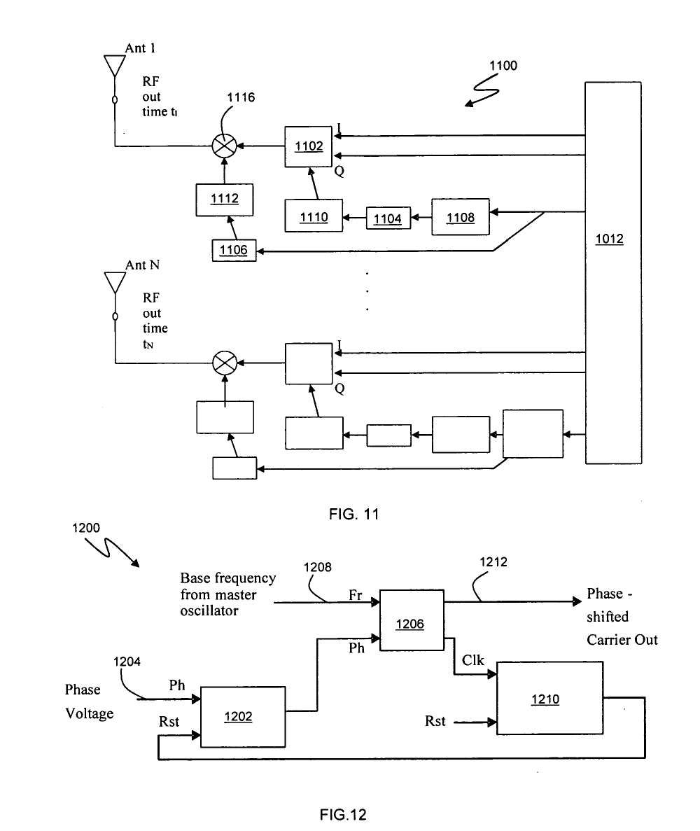

Referring now to FIG. 11, the transmit link 1100 or pathway is substantially the reverse of the transmit link 1000, and it includes a modulation module 1102 for receiving the IF signal. The stored, digitized offset value (in voltage form) is transmitted to two separate D/A converters 1104 and 1106. The signal transmitted to D/A converter 1104 first passes through an RF/IF divider 1108. An IF FShifter 1110 is interconnected to D/A converter 1104 and modulation module 1102. The digitized voltage is also directed to an RF FShifter 1112. Outputs of both IF FShifter 1110 and RF FShifter 1112 are inputs to a mixer 1114.

An integral element of the present disclosure is the phase shifted oscillator or FShifter. Referring now to FIG. 12, an FShifter 1200 (which may be either an IF FShifter or an RF FShifter) may include a voltage controller or “VShifter” 1202 for receiving an analog signal 1204 indicative of the phase offset, or alternatively the negated phase offset. Further, a voltage control oscillator or “VCO” 1206 is interconnected to voltage controller 1202. In addition to periodically receiving an input from VShifter 1202, VCO 1206 receives base frequency input 1208 from master oscillator 1004 (FIG. 10). As shown in FIG. 12, a shift register or counter 1210 is interconnected to both VCO 1206 and VShifter 1202. The output of FShifter 1200 is a phase-shifted carrier signal 1212. As noted in FIG. 12, other input/control signals, such as a clocking signal “Clk” or reset signal “Rst” are inputs or directions to FShifter 1200.

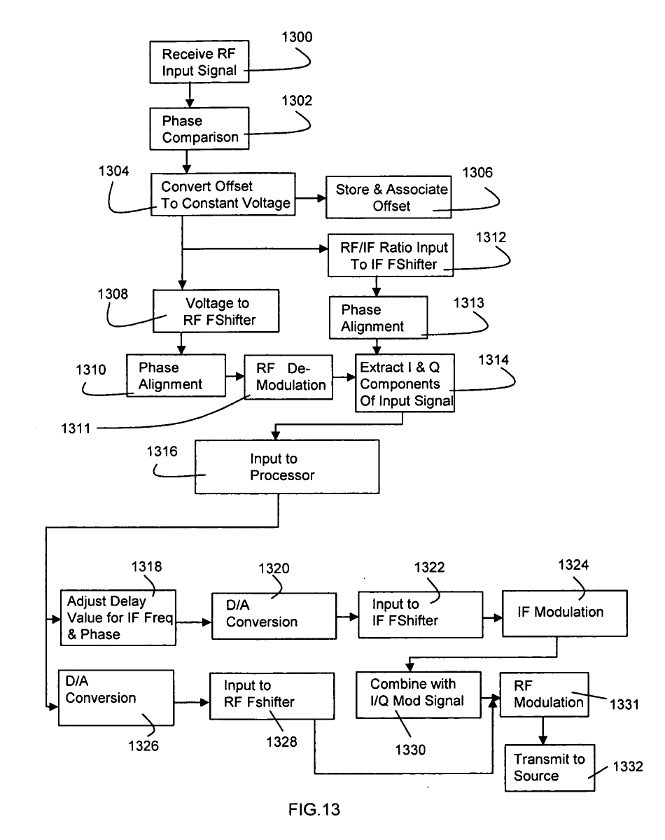

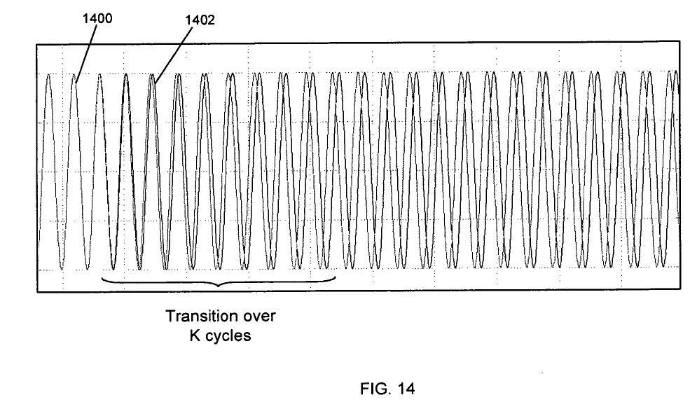

FIG. 13 is a flow diagram of the functional operation of at least one embodiment of a steerable antenna system of the present application, e.g. system 900. In the operation of the system 900, an RF input signal or carrier signal is received at each antenna element, block 1300. A phase detector compares the carrier phase to the master oscillator's known phase, block 1302. The offset, or delta phase derived from this comparison is converted into a constant voltage level by the phase detector, block 1304. Of note, each antenna element will have a phase voltage or phase offset unique to that antenna element. The converted voltage(s) are stored by antenna system 900 (for example in the processor), or alternatively a base station or host, and are associated with a specific source for future reference and use, block 1306.

The constant phase voltage is also directed to the RF version of the Fshifter, block 1308. With this input voltage, the RF Fshifter aligns the master oscillator phase to the specific antenna element phase for proper demodulation, block 1310. RF demodulation follows, block 1311. For proper IF demodulation, the IF phase must also be shifted. The amount of IF phase shift is determined by the ratio of RF/IF frequencies. This ratio value is inputted to the IF version of the Fshifter (block 1312), which is followed by phase alignment, block 1313. Output from the IF FShifter is used as input for proper extraction of the I and Q base band components, block 1314. These components are provided to the base band processing (block 1316) wherein they may be combined directly, resulting in some minor ISI (inter-symbol interference), or the phase delay information may be used for shifting any base band processing, such as the CDMA code generator, prior to combining the separate signals.

Considering now the transmit portion of system 900 operation, the phase delay information, that was stored in the receive cycle, is provided to the modulation module. For the I/Q modulation, this value is adjusted to the proper IF frequency and phase, again using the RF/IF ratio (block 1318), and converted from a digital value to an analog voltage, block 1320. The stored value is then inputted to the IF version of the Fshifter, block 1322, the output of which is input into the I/Q modulation module, block 1324.

Of note, the operation of the IF FShifter creates a carrier signal that is the same frequency as the IF frequency, however the carrier signal has a phase shift relative to the master oscillator that allows the beam to form in the proper direction. To accomplish this task, a window is defined where the frequency of the carrier signal is either higher or lower than the IF frequency for a specific number of cycles. The frequency is determined by

$${f}_{Shift} = \frac{K {f}_{carr}}{- {V}_{θ} + K} ,$$

where K is the window length, f_{carr} is the carrier frequency, and V_{θ} is the voltage measurement for the phase.

In particular, the voltage control oscillator or VCO generates the carrier frequency based on the master oscillator frequency and phase. The output cycles of the VCO are also shifting “1” s in the shift register or counter. After the K cycles, the output of the shift register goes to zero. During this window of “1”s, the Vshifter is outputting a delta voltage change based on the inputted phase voltage. The Vshifter is an implementation of the equation for f_{Shift}−f_{carr} or

$${f}_{Shift} - {f}_{carr} = \frac{{V}_{θ}}{K - {V}_{θ}} {f}_{carr} .$$

After the window, the V shifter goes to zero and maintains its shifted phase.

The RF modulation is done in a similar manner. The stored digital value is converted to an analog voltage, block 1326. This value is inputted to the RF version of the Fshifter for proper frequency and phase generation, block 1328. The outptut of the RF FShifter is mixed with the output of the I/Q Modulation to create the RF output signal, block 1330, and RF modulation (block 1331) is the final step prior to transmitting to the source, block 1332.

FIG. 14 is a representation of the shifted output of the IF or RF Shifter as discussed above. As shown, the output shifts from the phase of the master oscillator (as depicted by curve 1400) to the shifted phase of the output carrier or RF output signal (as depicted by curve 1402) over a predetermined number (“K”) cycles. As can be appreciated by referring to FIG. 14, once the phase has shifted the output signal returns to the original frequency and maintains the phase shift. In this manner, the RF output siganl, which is transmitted through the same antenna element as originally received, is directed or steered toward the source. Directional transmission of the RF output signal is accomplished using RF signal parameters, as opposed to digital signal processing to calculate a return direction.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure.

What is claimed is:

1. An antenna system comprising:
at least two antenna elements positioned to detect a radio frequency (“RF”) input signal from a source, and to transmit a corresponding phase-shifted RF output signal to the source;
a master oscillator;
a phase detector structured and arranged to measure a phase offset between the RF input signal and the master oscillator;
a first input phase shifted oscillator, positioned to receive the phase offset from the phase detector for demodulation of the RF input signal to an intermediate frequency (“IF”);
a second input phase shifted oscillator;
an input RF/IF divider positioned to receive the phase offset from the phase detector and, in concert with the second input phase shifted oscillator, to demodulate the IF signal;
an output RF/IF divider positioned to receive a negated phase offset value;
a first output phase shifted oscillator, structured and arranged to modulate, in concert with the output RF/IF divider, the IF signal; and;
a second output phase shifted oscillator structured and arranged to receive the negated phase offset and modulate an RF component of the RF output signal,
wherein the modulated IF signal and RF component combine to generate the RF output signal.

2. The antenna system of claim 1, further comprising:
a plurality of antenna elements, each element having a corresponding I and Q component; and
an I/Q splitter structured and arranged to split the RF input signal into I and Q components.

3. The antenna system of claim 1, further comprising at least one analog-to-digital converter positioned to digitize the phase offset upon receipt of the RF input signal, and to convert the digitized phase offset to analog.

4. The antenna system of claim 1, further comprising a processor structured and arranged to negate the phase offset and process RF input signal data.

5. The antenna system of claim 1, wherein the phase shifted oscillator comprises:
a voltage controlled oscillator;
a voltage controller, interconnected to the voltage controlled oscillator, structured and arranged to modify a voltage transmitted to the voltage controlled oscillator; and
a counter, interconnected to the voltage controller, to count a predetermined number of cycles during which the voltage transmitted to the voltage controlled oscillator is modified.

6. A method for directionally transmitting an RF output signal to a source, the method comprising:
detecting, with at least two antenna elements, an RF input signal from the source;
determining, for each antenna element, a phase offset between the RF input signal and a master oscillator;
negating the phase offset;
applying the negated phase offset in a phase shifted oscillator to shift a frequency of an output carrier signal from a first frequency to a second frequency for a predetermined number of cycles, thus shifting a phase of the output carrier. signal;
returning the output carrier signal to the first frequency;
modulating the output carrier signal with an intermediate frequency to generate the RF output signal; and
transmitting the RF output signal.

7. The method of claim 6, further comprising:
digitizing the phase offset prior to transmission of the phase offset to the processor;
storing the digitized phase offset; and
converting the negated phase offset to analog for transmission to the phase shifted oscillator.

8. The method of claim 6, wherein applying further comprises:
receiving the negated phase offset;
modifying a voltage transmitted to a voltage controlled oscillator using a voltage controller interconnected to the voltage controlled oscillator; and
activating a counter to count the predetermined number of cycles during which the voltage transmitted to the voltage controlled oscillator is modified.

9. The method of claim 6, further comprising:
shifting a phase of the RF input signal; and
demodulating the phase-shifted RF input signal to an IF frequency.

10. The method of claim 9, further comprising:
detecting the RF input signal with a plurality of antenna elements; and
adding a plurality of element specific intermediate frequency signals to generate the intermediate frequency.

11. A steerable antenna comprising:
a transmit/receive means for receiving an RF input signal from a source, and for transmitting an RF output signal to the source;
a determining means for determining a phase offset between the RF input signal and a master oscillator;
an applying means for applying the phase offset to the RF input signal to derive an intermediate frequency;
a negating means for negating the phase offset; and
a generating means for applying the negated phase offset to an output carrier signal, and for modulating the output carrier signal with the intermediate frequency, to generate the RF output signal.

12. The steerable antenna of claim 11, further comprising a means for digitizing the phase offset and for converting to analog the negated phase offset.

13. The steerable antenna of claim 11, wherein the transmit/receive means is two or more antenna elements.

14. The steerable antenna of claim 13, wherein a circuitry driven time delay for receiving the RF input signal is equal to a circuitry driven time delay for transmitting the RF output signal.

15. The steerable antenna of claim 11, wherein the generating means is a phase shifted oscillator.

16. The steerable antenna of claim 15, wherein the phase shifted oscillator comprises:
a voltage controlled oscillator;
a voltage controller, interconnected to the voltage controlled oscillator, to modify a voltage transmitted to the voltage controlled oscillator; and
a counter, interconnected to the voltage controller, to count a predetermined number of cycles during which the voltage transmitted to the voltage controlled oscillator is modified.

17. The steerable antenna of claim 11, wherein the determining means is a phase detector.

18. In a method of directionally transmitting an RF output signal to a source, of the type wherein an RF input signal is received from the source, and a direction for transmission to the source is determined using data derived from the RF input signal, the improvement comprising:
measuring a phase offset between the RF input signal and a master oscillator;
negating the phase offset;
applying the negated phase offset in a phase shifted oscillator to shift a frequency of an output carrier signal from a first frequency to a second frequency for a predetermined number of cycles, thus shifting a phase of the output carrier signal;
returning the output carrier signal to the first frequency; and
modulating the output carrier signal with an intermediate frequency to generate the RF output signal.

19. The method of claim 18, further comprising:
shifting a phase of the RF input signal; and
demodulating the phase-shifted RF input signal to an IF frequency.

20. The method of claim 18, wherein the phase shifted oscillator comprises:
a voltage controlled oscillator;
a voltage controller, interconnected to the voltage controlled oscillator, to modify a voltage transmitted to the voltage controlled oscillator; and
a counter, interconnected to the voltage controller, to count a predetermined number of cycles during which the voltage transmitted to the voltage controlled oscillator is modified.
